(19) United States
(12) Patent Application Publication
(10) Pub. No.: US 2026/0316762 A1
(43) Pub. Date: Oct. 15, 2026

(54) VEHICLE OPERATING ASSISTANCE APPARATUS

(71) Applicant: SUBARU CORPORATION, Tokyo (JP)

(72) Inventors: Shinichiro NAKAHIRA, Tokyo (JP); Yuto FUJII, Tokyo (JP); Naoto CHIBA, Tokyo (JP); Nobuo MORIMURA, Tokyo (JP); Toshiki SATO, Tokyo (JP); Takuro TERADA, Tokyo (JP); Hirokazu KAJI, Tokyo (JP); Susumu YAMAGATA, Tokyo (JP); Kinnosuke MASUDA, Tokyo (JP); Shinji SAWADA, Tokyo (JP); Toshiki MOTOMURA, Tokyo (JP)

(21) Appl. No.: 19/636,157

(22) Filed: Apr. 1, 2026

Related U.S. Application Data
(63) Continuation of application No. PCT/JP2023/038499, filed on Oct. 25, 2023.

(51) Int. Cl. B60W 30/18; B60W 40/068

(52) U.S. Cl. CPC B60W 30/18172; B60W 40/068; B60W 2552/05; B60W 2552/10; B60W 2552/40; B60W 2555/20; B60W 2556/40; B60W 2556/45; B60W 2720/26

(57) ABSTRACT

A vehicle operating assistance apparatus includes an obtainer that obtains driving environment information and a controller. The controller includes: an obtainer that obtains road information; a detector that detects a minimum road surface friction coefficient; a calculator that calculates an actuating force; a calculator that calculates a road surface grip force of a drive wheel; a comparator that compares the actuating force with the road surface grip force; a controller that performs driving assistance control; a setter that divides the travel route ahead of the vehicle; and an updater that updates road surface information. The detector detects the minimum road surface friction coefficient in a travel section that is set by the travel section setter, based on the driving environment information. The updater updates road surface information regarding a present travel section when the comparator determines that the actuating force exceeds the road surface grip force.

### CROSS REFERENCE TO RELATED APPLICATIONS

This application is continuation of International Application No. PCT/JP2023/038499, filed on Oct. 25, 2023, the entire contents of which are hereby incorporated by reference.

### BACKGROUND

The disclosure relates to vehicle operating assistance apparatuses.

While the driver is operating the vehicle, the vehicle can behave unexpectedly due to road conditions or weather changes. For example, when the road surface is partially frozen, the vehicle can slip momentarily as the vehicle passes over the frozen road surface.

In another example, the vehicle can also slip momentarily when the tires pass over, for example, metal joints at bridge seams, snow, or fallen leaves. In front-wheel drive vehicles, in which the drive wheels also serve as steering wheels, a front wheel slip makes steering the vehicle difficult.

If a slip occurs when the vehicle is travelling, the vehicle's behavior becomes unstable, causing the occupants, including the driver, to feel uneasy.

For example, in the technology disclosed in Japanese Unexamined Patent Application Publication (JP-A) No. 2023-103513, firstly in the automated operating mode, a driving control unit determines the slip condition of the tires based on the tires' rotation speed and estimates the road surface friction coefficient. Based on this road surface friction coefficient, it is determined whether the road surface is slippery. When the road surface is determined to be slippery, the driving control unit activates the low friction-coefficient driving mode. In this low friction-coefficient driving mode, the steering speed is set to slow, the brake timing is set to an earlier point, and the upper limit speed and upper limit acceleration rate are set to low values.

While the low friction-coefficient driving mode is active, the driving control unit detects the degree of uneasiness based on, for example, the frequency of movement in the driver's line of sight. When it is determined that the driver is feeling uneasy, the steering speed and brake timing are further adjusted. This adjustment helps mitigate the driver's uneasiness.

Road surface conditions continuously change with the driving environment. To prevent travelling vehicles from slipping, changes in the road surface friction coefficient that can occur in the future is to be predicted early.

### SUMMARY

An aspect of the disclosure provides a vehicle operating assistance apparatus configured to be applied to a vehicle. The vehicle includes a driving environment information obtainer and a controller. The driving environment information obtainer is configured to obtain driving environment information regarding an area ahead of the vehicle. The controller includes a road information obtainer, a minimum road surface friction coefficient detector, an actuating force calculator, a road surface grip force calculator, a comparator, and a driving assistance controller. The road information obtainer is configured to obtain road information based on the driving environment information obtained by the driving environment information obtainer. The minimum road surface friction coefficient detector is configured to detect a minimum road surface friction coefficient based on the road information obtained by the road information obtainer. The actuating force calculator is configured to calculate an actuating force based on torque of an actuator. The road surface grip force calculator is configured to calculate a road surface grip force of a drive wheel based on the minimum road surface friction coefficient detected by the minimum road surface friction coefficient detector. The comparator is configured to compare the actuating force calculated by the actuating force calculator with the road surface grip force calculated by the road surface grip force calculator. The driving assistance controller is configured to, when the comparator determines that the actuating force exceeds the road surface grip force, perform a driving assistance control. The controller further includes a travel section setter and a road surface information updater. The travel section setter is configured to divide a travel route ahead of the vehicle based on a predetermined travel section criterion. The road surface information updater is configured to update road surface information stored in road map data. The minimum road surface friction coefficient detector is configured to detect the minimum road surface friction coefficient in a travel section that is set by the travel section setter, based on the driving environment information obtained by the driving environment information obtainer. The road surface information updater is configured to, when the comparator determines that the actuating force exceeds the road surface grip force, update road surface information regarding a present travel section, the road surface information being stored in the road map data.

An aspect of the disclosure provides a vehicle operating assistance apparatus configured to be applied to a vehicle. The vehicle operating assistance apparatus includes a driving environment information obtainer and circuitry. The driving environment information obtainer includes a camera and is configured to obtain driving environment information regarding an area ahead of the vehicle. The circuitry is configured to: obtain road information based on the driving environment information obtained by the driving environment information obtainer; detect a minimum road surface friction coefficient based on the road information; calculate an actuating force based on torque of an actuator; calculate a road surface grip force of a drive wheel based on the minimum road surface friction coefficient: compare the actuating force with the road surface grip force; and when determining that the actuating force exceeds the road surface grip force, perform a driving assistance control. The circuitry is further configured divide a travel route ahead of the subject based on a predetermined travel section criterion, and update road surface information stored in road map data. The circuitry is configured to detect the minimum road surface friction coefficient in a travel section that is set by dividing the travel route, based on the driving environment information obtained by the driving environment information obtainer. The circuitry is configured to, when determining that the actuating force exceeds the road surface grip force, update road surface information regarding a present travel section, the road surface information being stored in the road map data.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates a schematic configuration of a vehicle operating assistance apparatus;

FIG. 2 is a flowchart illustrating an estimated road surface μ setting routine;

FIG. 3 is a flowchart illustrating a per travel-section slip detection routine;

FIG. 4A is a conceptual diagram of a basic road surface μ setting map based on a road type;

FIG. 4B is a conceptual diagram of a weather adjustment coefficient setting map;

FIG. 4C is a conceptual diagram of a tire adjustment coefficient setting map;

FIG. 4D is a conceptual diagram of a road surface μ adjustment coefficient setting map based on a road surface type;

FIG. 5 illustrates a case where a road surface μ is estimated for each section; and

FIG. 6 illustrates the relationship between the actuating force of a drive tire and the road surface grip force.

### DETAILED DESCRIPTION

In the technology disclosed in JP-A No. 2023-103513, the low friction-coefficient driving mode is activated after the vehicle's slip has been detected. Additionally, at the same time, the degree of driver's uneasiness is determined, and the operation to mitigate the uneasiness of the driver is performed. As a result, this configuration can easily cause a momentary delay before implementing slip-prevention control. Moreover, the control to mitigate uneasiness is not initiated until the driver experiences uneasiness, which can also cause a momentary delay before implementing control.

In view of the above circumstances, it is desirable to provide vehicle operating assistance apparatuses capable of suppressing the occurrence of slip, thereby significantly reducing the uneasiness felt by occupants including drivers.

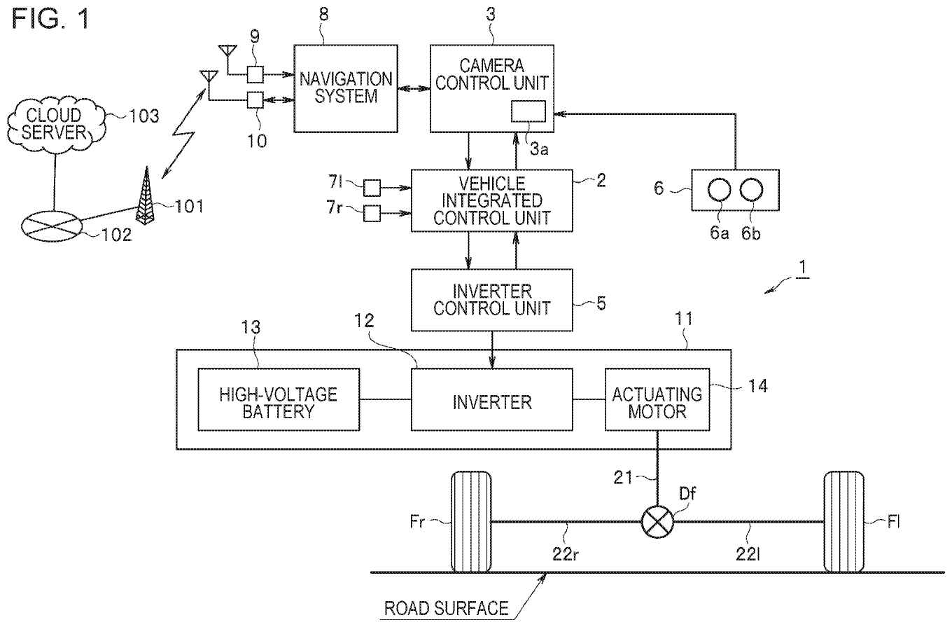

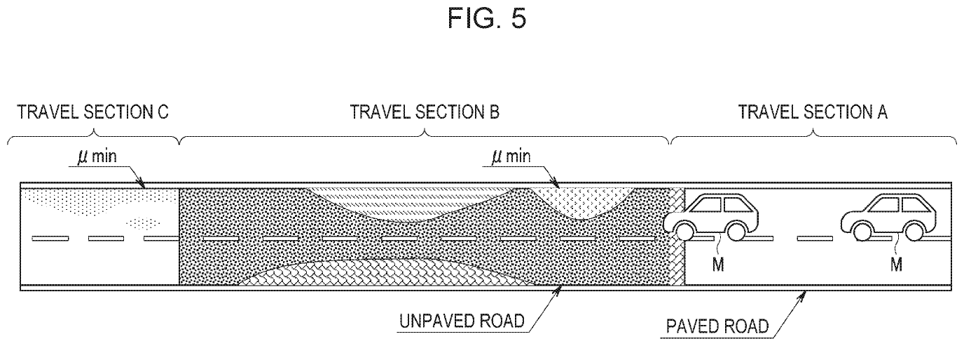

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. The reference numeral 1 in FIG. 1 represents a vehicle operating assistance apparatus. This vehicle operating assistance apparatus 1 is installed in a vehicle M (see FIG. 5). The vehicle M is an electric vehicle. In the following description, the vehicle M will be referred to as the electric vehicle M.

The vehicle operating assistance apparatus 1 includes a vehicle integrated control unit 2. This vehicle integrated control unit 2 comprehensively performs various controls related to the operation of the electric vehicle M. A camera control unit 3, left and right side-view cameras 7l and 7r are coupled to this vehicle integrated control unit 2. Although not illustrated, various sensors designed to obtain information for operating the electric vehicle M are coupled to the vehicle integrated control unit 2. In one embodiment, the vehicle integrated control unit 2 and the camera control unit 3 may serve as a “controller”.

The side-view cameras 7l and 7r are attached to the left and right front sides the vehicle body. The side-view cameras 7l and 7r capture images of the left and right sides relative to the vehicle body. The vehicle integrated control unit 2 detects the movement speed of the road surface and the movement speed of the tires serving as drive wheels Fl and Fr at the road surface contact positions at which the tires contact the road surface, based on the images captured by the side-view cameras 7l and 7r.

Additionally, an inverter control unit 5 is coupled to the vehicle integrated control unit 2. Although not illustrated, the vehicle integrated control unit 2 is coupled to the various control units in a manner that enables bidirectional communication.

The control units 2, 3, and 5, as well as a navigation system 8, which will be described later, are implemented by microcontrollers that include a central processing unit (CPU), a random-access memory (RAM), a read-only memory (ROM), and a rewritable non-volatile memory (flash memory or electrically erasable programmable read-only memory (EEPROM)), equipped with peripheral devices. The ROM stores programs, fixed data, and other information for the CPU to perform various operations. The RAM is provided as a work area for the CPU. The RAM temporarily stores various data to be processed by the CPU. The CPU is also referred to as a microprocessor (MPU) or processor. In place of the CPU, a graphics processing unit (GPU) or graph streaming processor (GSP) may be used. Alternatively, a CPU, a GPU, and a GSP may be selectively combined.

An inverter 12 of an electric-powered powertrain 11 is coupled to the inverter control unit 5. The electric-powered powertrain 11 includes the inverter 12, a high-voltage battery 13, and an actuating motor 14 as the actuator. The inverter 12 operates based on an instruction signal from the inverter control unit 5. Based on the instruction signal from the inverter control unit 5, the inverter 12 converts direct-current (DC) power from the high-voltage battery 13 into alternating-current (AC) power and supplies the AC power to the actuating motor 14. The inverter control unit 5 controls the actuating force of the actuating motor 14 using vector control.

An output shaft 21 of the actuating motor 14 is provided in connection with actuating shafts 22l and 22r of the left and right drive wheels Fl and Fr via a differential Df. The actuating motor 14 powers the electric vehicle M by actuating the drive wheels Fl and Fr using the power supplied from the inverter 12.

A camera unit 6 is installed as a driving environment detector at the front part of the electric vehicle M. The camera unit 6 includes a stereo camera consisting of a main camera 6a and a sub-camera 6b.

This camera unit 6 is coupled to the input side of the camera control unit 3. The camera control unit 3 obtains front driving environment information by processing driving environment images of the area ahead of the electric vehicle M, captured by the cameras 6a and 6b of the camera unit 6.

Information regarding the currently attached tires is previously stored in a non-volatile memory 3a provided in the camera control unit 3. This tire information is input by the user or the driver who drives the vehicle when the tires are attached. The tire information includes, for example, a tire type and the replacement timing. The tire type indicates, for example, a normal tire, studless tire, or the tire size.

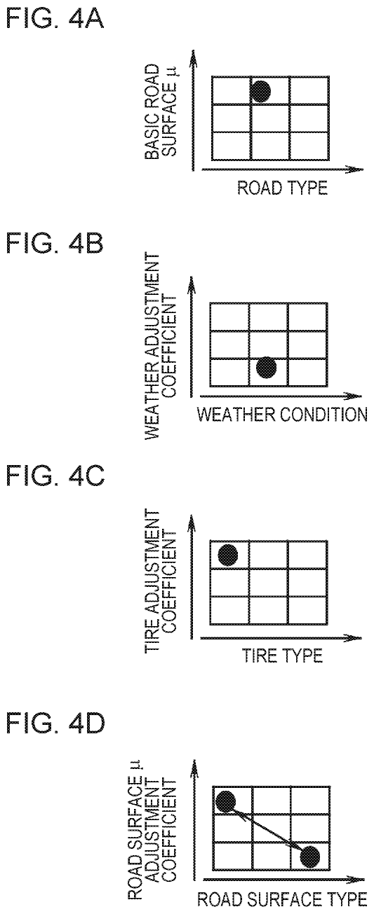

Additionally, various maps are stored in the non-volatile memory 3a. The maps include a basic road surface μ setting map (see FIG. 4A), which is read to set the initial value for a predicted road surface μ, a weather adjustment coefficient setting map (see FIG. 4B), and a tire adjustment coefficient setting map (see FIG. 4C). Additionally, a road surface μ adjustment coefficient setting map (see FIG. 4D) is also stored in the non-volatile memory 3a.

As illustrated in FIG. 4A, the basic road surface μ setting map stores basic road surface μ data that is preset for different road types. Examples of the road types include paved road (concrete road surface, asphalt road surface) and unpaved road (gravel road, dirt road). A smaller value of the basic road surface μ is set for the unpaved road than the paved road.

As illustrated in FIG. 4B, adjustment coefficients (with adjustment coefficient values≤1) corresponding to different weather conditions are set in the weather adjustment coefficient setting map. These adjustment coefficients decrease to lower values in the following order: sunny>cloudy>rainy>snow.

As illustrated in FIG. 4C, adjustment coefficients (with adjustment coefficient values≤1) corresponding to different tire types are set in the tire adjustment coefficient setting map. The adjustment coefficient for normal tire is set higher than for studless tire. As the tire aspect ratio increases, the set adjustment coefficient increases.

As illustrated in FIG. 4D, road surface μ adjustment coefficients corresponding to different road surface types are set in the road surface μ adjustment coefficient setting map. Regardless of whether the roads are paved roads, lower values of the road surface μ are set for snowy or rainy roads compared to dry road surfaces. The rates at which the road surface μ decrease are predetermined for different road surface types through experiments or other methods and preset in the road surface μ adjustment coefficient setting map.

Additionally, the navigation system 8 is coupled to the camera control unit 3. A global navigation satellite system (GNSS) receiver 9 and a road information transceiver 10 are coupled to the navigation system 8.

The navigation system 8 obtains information of the vehicle location (latitude, longitude, altitude) based on positioning signals from multiple positioning satellites, received by the GNSS receiver 9. The navigation system 8 includes a storage that stores road map data. The road map data includes static information and dynamic information. The static information includes road information indicating, for example, paved road or unpaved road. The dynamic information includes weather information that changes in real time.

The weather information includes, for example, weather conditions such as sunny, rainy, and snow, sunshine conditions, rainfall amount, snowfall amount, temperature, humidity, and air pressure. The weather information may be obtained from meteorological information provided by websites.

The navigation system 8 plots the vehicle location estimated based on the positioning signal received by the GNSS receiver 9 on the road map data and estimates the present vehicle location on the road map and the travel direction. The navigation system 8 then constructs a travel route connecting the destination input by, for example, the driver to the vehicle location on the road map.

The navigation system 8 is able to access the cloud server 103 from the road information transceiver 10 via a base station 101 and a network 102. The navigation system 8 obtains the latest road map data (static information, dynamic information) for the area around the vehicle from the cloud server 103. In one embodiment, the camera unit 6 and the navigation system 8 may serve as a “driving environment information obtainer”.

The navigation system 8 obtains road information for the area around the vehicle based on the road map data. The obtained road information is transmitted to the camera control unit 3.

The camera control unit 3 sets a section criterion that determines a specific distance at which the travel route set on the road map is to be divided. This travel section criterion can be set based on the road information regarding the area ahead of the vehicle location obtained by the navigation system 8 and the driving environment information regarding the area ahead of the vehicle obtained from the images captured by the camera unit 6. The section criterion is constantly updated. While the electric vehicle M is traveling on the road that has been divided into travel sections, the travel route ahead of the electric vehicle M is divided.

The camera control unit 3 divides the travel route from the front of the vehicle to a preset distance, based on the set travel section criterion. The camera control unit 3 sets a minimum road surface μmin in a travel section. The camera control unit 3 sets the minimum road surface μmin for each travel section.

When the electric vehicle M enters a travel section of the road that has been divided, the vehicle integrated control unit 2 controls a actuating force P of the drive wheels Fl and Fr based on the minimum road surface μmin set in the travel section.

While the electric vehicle M is driving, a slip occurs when the actuating force P provided by the actuating motor 14 to the tires (referred to as “drive tires”) serving as the drive wheels Fl and Fr exceeds a grip force Ft (referred to as “road surface grip force”) from the road surface acting on the drive tires (P>Ft).

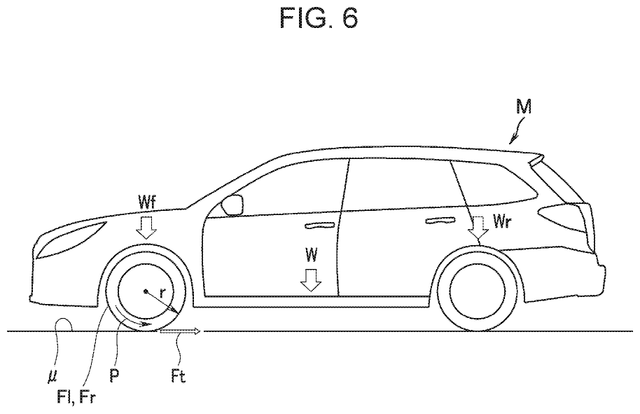

As illustrated in FIG. 6, the actuating force P of the drive tire (front wheel in the drawing) in the electric vehicle M is given by

P=T/r (1)

where T represents the torque and r represents the effective radius of the drive tire.

The road surface grip force F is given by

F=μ·Wf (2)

where μ represents the road surface friction coefficient and Wf represents the vehicle body weight on the drive tire (front wheel).

In FIG. 6, W represents the total vehicle body weight and Wr represents the vehicle body weight on the driven tire (rear wheel).

The electric vehicle M can continue driving without experiencing slip by setting the actuating force P such that the relationship P≤F is always maintained, with the road surface grip force F that being set based on the minimum road surface μmin.

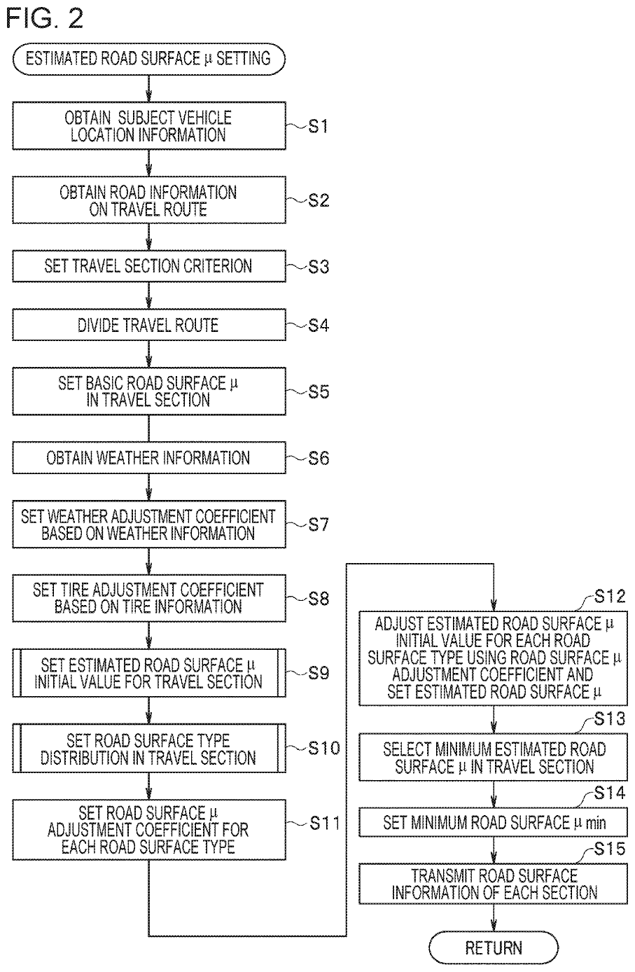

Setting of the minimum road surface μmin for each travel section using the camera control unit 3 is performed according to, for example, an estimated road surface μ setting routine illustrated in FIG. 2.

The camera control unit 3 first obtains the vehicle location information estimated by the navigation system 8 (step S1). Next, the camera control unit 3 searches the road map data for the travel route ahead of the vehicle location, based on the vehicle location, and obtains the driving environment information on the travel route (step S2). This driving environment information includes the road information obtained based on the images captured by the camera unit 6, the static information stored in the road map data, and the dynamic information. In one embodiment, the operation in step S2 may serve as an operation performed by a “road information obtainer”.

Next, the camera control unit 3 sets a travel section criterion based on the driving environment information (step S3). The travel section criterion is used to perform sectioning based on factors such as the distance that the electric vehicle M has traveled from the location at which the travel route was divided in the previous operation, the time interval that has been preset in advance, the lane to which the electric vehicle M has changed from the previous lane, a road type (for example, paved road, unpaved road), road sunshine (sunny area, shaded area), a road surface condition (dry, wet), and a snow surface condition (uncleared snow, cleared snow). A specific factor can be selected for the travel section criterion to divide travel sections. FIG. 5 illustrates a case where the criterion of whether the road is paved or unpaved is set to divide travel sections. This travel section criterion can be changed at any time.

The camera control unit 3 divides the travel route on which the electric vehicle M is traveling, based on the set travel section criterion (step S4). In one embodiment, the operations in steps S3 and S4 may serve as operations performed by a “travel section setter”.

In the case where the criterion of whether the road is paved or unpaved is set as the travel section criterion, in the travel route illustrated in FIG. 5, a travel section A, in which the electric vehicle M is currently travelling, is divided as paved road, a travel section B, which follows the travel section A, is divided as unpaved road, and a travel section C, which follows the travel section B, is divided as paved road. This travel section division is performed within the range that the road conditions can be detected based on the images captured by the camera unit 6.

Subsequently, the camera control unit 3 sets a basic road surface μ corresponding to each obtained road type by referencing the basic road surface μ setting map (FIG. 4A), based on the types of the divided roads (step S5). The basic road surface μ setting map stores a road surface μ for each road type that is predetermined through experiments or other methods.

The camera control unit 3 obtains the present weather information regarding the area around the vehicle location from the dynamic information of the road map data or the meteorological information provided by websites (step S6). Based on this weather information, the camera control unit 3 sets a weather adjustment coefficient by referencing the weather adjustment coefficient setting map (FIG. 4B) (step S7).

The camera control unit 3 sets a tire adjustment coefficient based on the tire information of the electric vehicle M stored in advance in the non-volatile memory 3a by referencing the tire adjustment coefficient setting map (FIG. 4C) (step S8).

The camera control unit 3 sets an estimated road surface μ initial value by multiplying the basic road surface μ, which is set for each travel section, by either the average value of the weather adjustment coefficient and the tire adjustment coefficient, or the lower value of the weather adjustment coefficient and the tire adjustment coefficient (step S9). To set an estimated road surface μ initial value, information (for example, slip information and road surface μ information) of other vehicles in the same travel section may be obtained by accessing the cloud server 103, and the estimated road surface μ initial value may be set considering this other vehicle information.

Subsequently, the camera control unit 3 sets a road surface type distribution in the travel section (step S10). For example, although both the travel sections A and B illustrated in FIG. 5 indicate paved roads, the road surface can be categorized under different types such as asphalt pavement or concrete pavement. The road surface μ varies among these types. In another example, as illustrated in the travel section C, the paved road includes some shaded areas that have snowdrifts or icy surfaces. In another example, as the travel section B illustrated in FIG. 5, although the unpaved road is mostly a gravel road, the gravel road includes some areas where the dirt road is exposed, gravel is unevenly accumulated, or the road is muddy. As such, when the road is categorized under the same road type such as paved or unpaved, the road surface μ varies depending on the road surface condition.

This road surface type distribution is identified through image recognition, for example, utilizing artificial intelligence (AI), based on the front image captured by the camera unit 6, while dividing a single frame of image data into different road surface types. This road surface type distribution provides information to track changes in the present road surface in real time.

Next, the camera control unit 3 sets a road surface μ adjustment coefficient corresponding to each road surface type identified by AI by referencing the road surface μ adjustment coefficient setting map (FIG. 4D) for each road surface type (step S11). In this road surface μ adjustment coefficient setting map, the adjustment coefficients for different road surface types are predetermined through experiments or other methods and set.

The camera control unit 3 adjusts the set estimated road surface μ initial value using the road surface μ adjustment coefficient and sets an estimated road surface μ for each road surface type (step S12).

Next, the minimum estimated road surface μ among the estimated road surfaces μ that are set in a travel section is selected (step S13). The camera control unit 3 sets the selected minimum estimated road surface μ as the minimum road surface μmin (step S14). The camera control unit 3 transmits the road surface information of the travel section including the minimum road surface μmin as road information to the vehicle integrated control unit 2 (step S15), and exits the routine. In one embodiment, the operations in steps S13 and S14 may serve as operations performed by a “minimum road surface friction coefficient detector”.

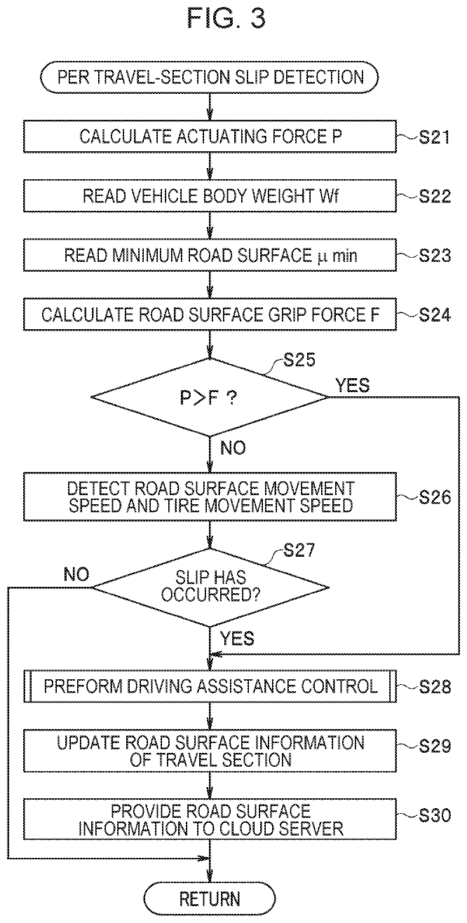

The vehicle integrated control unit 2 reads the road surface information for each travel section from the camera control unit 3 and detects whether a slip has occurred when the electric vehicle M is driven under real circumstances. Detection of whether a slip has occurred in each travel section, performed by the vehicle integrated control unit 2, is conducted according to, for example, a per travel-section slip detection routine illustrated in FIG. 3.

In the actuating motor 14 of the electric vehicle M, the actuating force is controlled using vector control. In vector control, the current flowing through the motor is separated into a current component (torque current component) that generates torque and a current component (magnetic flux current component) that generates magnetic flux in a rotor, and the current components are controlled individually. The vehicle integrated control unit 2 first calculates the actuating force P to be provided to the drive wheels Fl and Fr based on the torque current component (step S21). In one embodiment, the operation in step S21 may serve as an operation performed by an “actuating force calculator”.

Next, the vehicle integrated control unit 2 reads the vehicle body weight Wf applied to the tires serving as the drive wheels Fl and Fr (step S22). This vehicle body weight Wf is stored in advance in the non-volatile memory 3a. The vehicle integrated control unit 2 also reads the minimum road surface μmin of the travel section in which the electric vehicle M is currently driving (step S23).

The vehicle integrated control unit 2 calculates the road surface grip force F of the drive tires, based on the vehicle body weight Wf and the minimum road surface μmin (F=μmin·Wf) (step S24). In one embodiment, the operation in step S24 may serve as an operation performed by a “road surface grip force calculator”.

Subsequently, the vehicle integrated control unit 2 compares the actuating force P with the road surface grip force F (step S25). In one embodiment, the operation in step S25 may serve as an operation performed by a “comparator”.

When P>F (YES in step S25), a slip is predicted to occur. When P≤F (NO in step S25), the vehicle integrated control unit 2 determines that the probability of slip occurrence is low. When a slip is predicted to occur, the vehicle integrated control unit 2 performs driving assistance control (step S28). The road surface grip force F is calculated based on the minimum road surface μmin in step S24. As a result, using the relationship P>F enables a prediction of slip occurrence in the shortest possible time.

When it is determined that the probability of slip occurrence is low, the vehicle integrated control unit 2 detects the movement speed of the road surface and the movement speed of the tires serving as the drive wheels Fl and Fr at the road surface contact positions, based on the images captured by the left and right side-view cameras 7l and 7r (step S26).

The vehicle integrated control unit 2 determines whether a slip has occurred, based on the movement speed of the road surface and the movement speed of the tires serving as drive wheels Fl and Fr at the road surface contact positions (step S27). As described above, using the relationship P>F enables a prediction of slip occurrence in the shortest possible time. However, although the minimum road surface μmin is set, unexpected slips can still occur under real circumstances, depending on driving conditions.

For this reason, the vehicle integrated control unit 2 verifies whether slips occur under real circumstances. When the difference between the movement speed of the road surface and the movement speed of the tires at the road surface contact positions is less than a slip determination speed, which is set to determine slip occurrence (NO in step S27), the vehicle integrated control unit 2 determines that no slip has occurred, and the routine is exited.

When the movement speed of the tires serving as the drive wheels Fl and Fr at the road surface contact positions is fast relative to the movement speed of the road surface, and the difference between the movement speed of the tires and the movement speed of the road surface is greater than or equal to the slip determination speed (YES in step S27), the vehicle integrated control unit 2 determines that a slip has occurred. In one embodiment, the operation in step S27 may serve as an operation performed by a “slip occurrence determiner”. When it is determined that a slip has occurred, the vehicle integrated control unit 2 performs driving assistance control (step S28). In one embodiment, the operation in step S28 may serve as an operation performed by a “driving assistance controller”.

Here, the driving assistance control performed by the vehicle integrated control unit 2 is a control for suppressing slip occurrence. The driving assistance control includes, for example, limiting the upper limit of the acceleration rate of the electric vehicle M, increasing the lower limit of the inter-vehicle distance to the preceding vehicle, and increasing a threshold for collision-preventing braking of the electric vehicle M with respect to the preceding vehicle. The vehicle integrated control unit 2 performs one of these controls, or a combination of two or more of these controls.

The driving assistance control performed by the vehicle integrated control unit 2 may be a control to notify the driver of slip occurrence, instead of the controls described above. The control to notify the driver of slip occurrence can be performed, for example, by applying reaction force or vibration to the accelerator pedal and the brake pedal.

By applying reaction force or vibration to the accelerator pedal and the brake pedal, the driver is prevented from pressing the accelerator pedal or the brake pedal excessively. This configuration suppresses slip occurrence. To apply reaction force and vibration, pressurizing actuators are provided for the accelerator pedal and the brake pedal, and the vehicle integrated control unit 2 operates the pressurizing actuators.

Subsequently, the vehicle integrated control unit 2 updates the road map data stored in the navigation system 8 (step S29). The update target is the road surface information of the present travel section. The road surface information to be updated includes, for example, the travel section in which the slip occurrence is detected, the time at which the slip occurrence is detected, and the minimum road surface μmin measured at the time. In one embodiment, the operation in step S29 may serve as a process performed by a “road surface information updater”.

The vehicle integrated control unit 2 transmits the road surface information to the cloud server 103 via the network 102 (step S30) and exits the routine. The cloud server 103 stores the received road surface information as the road surface information regarding the travel section in which the electric vehicle M has driven and provides the road surface information to other vehicles.

As described above, in the present embodiment, the travel route on which the electric vehicle M drives is divided based on the preset travel section criterion. The minimum road surface μmin in the travel section is detected, and the road surface grip force F is calculated based on the minimum road surface μmin. When the electric vehicle M drives in the travel section while maintaining the relationship P≤F, slip occurrence can be prevented.

When P≤F is estimated, there is a possibility that slips can still occur under real circumstances. For this reason, in the present embodiment, when P≤F is estimated, whether a slip occurs under real circumstances is verified based on the images captured by the side-view cameras 7l and 7r. When a slip occurrence is detected, operating assistance is activated. This configuration helps suppress slip occurrence, thereby achieving higher driving stability. As a result, this configuration significantly reduces the uneasiness felt by occupants including drivers.

It is noted that the electric vehicle M may be a four-wheel drive vehicle. The estimated road surface μ setting routine illustrated in FIG. 2 may be performed by the vehicle integrated control unit 2. When the vehicle integrated control unit 2 detects slip occurrence, the vehicle integrated control unit 2 may provide a notification using sound or images on a monitor.

The vehicle integrated control unit 2 and the camera control unit 3 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle integrated control unit 2 and the camera control unit 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle operating assistance apparatus configured to applied to a vehicle, the operating assistance apparatus comprising:
a driving environment information obtainer configured to obtain driving environment information regarding an area ahead of the vehicle; and
a controller, wherein
the controller comprises
a road information obtainer configured to obtain road information based on the driving environment information obtained by the driving environment information obtainer,
a minimum road surface friction coefficient detector configured to detect a minimum road surface friction coefficient based on the road information obtained by the road information obtainer,
an actuating force calculator configured to calculate an actuating force based on torque of an actuator,
a road surface grip force calculator configured to calculate a road surface grip force of a drive wheel based on the minimum road surface friction coefficient detected by the minimum road surface friction coefficient detector,
a comparator configured to compare the actuating force calculated by the actuating force calculator with the road surface grip force calculated by the road surface grip force calculator, and
a driving assistance controller configured to, when the comparator determines that the actuating force exceeds the road surface grip force, perform a driving assistance control,
the controller further comprises
a travel section setter configured to divide a travel route ahead of the vehicle based on a predetermined travel section criterion, and
a road surface information updater configured to update road surface information stored in road map data,
the minimum road surface friction coefficient detector is configured to detect the minimum road surface friction coefficient in a travel section that is set by the travel section setter, based on the driving environment information obtained by the driving environment information obtainer, and
the road surface information updater is configured to, when the comparator determines that the actuating force exceeds the road surface grip force, update, with the road surface information, road surface information that relates to a present travel section and is stored in the road map data.

2. The vehicle operating assistance apparatus according to claim 1, wherein
the controller further comprises
a slip occurrence determiner, wherein
the road surface information updater is configured to, when the comparator determines that the actuating force does not exceed the road surface grip force and the slip occurrence determiner determines that a slip occurred, update, with the road surface information, road surface information that relates to a present travel section and is stored in the road map data.

3. The vehicle operating assistance apparatus according to claim 1, wherein
the travel section criterion includes one or more of a distance that the vehicle traveled from a location at which a travel route was divided in a previous operation, a preset time interval, a lane to which the vehicle changed from a previous lane, a road type, road sunshine, a road surface condition, and a snow surface condition.

4. The vehicle operating assistance apparatus according to claim 3, wherein
the travel section criterion is changeable.

5. The vehicle operating assistance apparatus according to claim 1, wherein
the driving assistance control performed by the driving assistance controller is a control for suppressing slip occurrence.

6. The vehicle operating assistance apparatus according to claim 1, wherein
the controller is configured to transmit the road surface information updated by the road surface information updater to a cloud server via a network.

7. The vehicle operating assistance apparatus according to claim 2, wherein
the controller is configured to transmit the road surface information updated by the road surface information updater to a cloud server via a network.

8. The vehicle operating assistance apparatus according to claim 3, wherein
the controller is configured to transmit the road surface information updated by the road surface information updater to a cloud server via a network.

9. The vehicle operating assistance apparatus according to claim 4, wherein
the controller is configured to transmit the road surface information updated by the road surface information updater to a cloud server via a network.

10. The vehicle operating assistance apparatus according to claim 5, wherein
the controller is configured to transmit the road surface information updated by the road surface information updater to a cloud server via a network.

11. A vehicle operating assistance apparatus configured to be applied to a vehicle, the vehicle operating assistance apparatus comprising:
a driving environment information obtainer including a camera, the driving environment information obtainer being configured to obtain driving environment information regarding an area ahead of the vehicle;
one or more processors; and
one or more memories communicably coupled to the one or more processors, the one or more memories storing instructions configured to cause the one or more processors to carry out processing, the processing including
obtaining road information based on the driving environment information obtained by the driving environment information obtainer,
detecting a minimum road surface friction coefficient based on the road information,
calculating an actuating force based on torque of an actuator,
calculating a road surface grip force of a drive wheel based on the minimum road surface friction coefficient,
comparing the actuating force with the road surface grip force, and
when determining that the actuating force exceeds the road surface grip force, performing a driving assistance control,
the processing further includes
dividing a travel route ahead of the vehicle based on a predetermined travel section criterion, and
updating road surface information stored in road map data,
the detecting of the minimum road surface friction coefficient includes detecting a minimum road surface friction coefficient in a travel section that is set by dividing the travel route based on the driving environment information obtained by the driving environment information obtainer, and
the updating of the road surface information includes, when the one or more processors determines that the actuating force exceeds the road surface grip force, updating road surface information regarding a present travel section and being stored in the road map data.
